(19) United States
(12) Patent Application Publication
(10) Pub. No.: US 2007/0022974 A1
(43) Pub. Date: Feb. 1, 2007

(54) Animal-wearable device with warning

(76) Inventor: Caroline Esther Aebi, San Mateo, CA (US)

Correspondence Address: LOUIS WU, P.O. BOX 10074, OAKLAND, CA, 94610, US

(21) Appl. No.: 11/491,601

(22) Filed: Jul. 24, 2006

Related U.S. Application Data
(60) Provisional application No. 60/704,289, filed on Aug. 1, 2005.

(51) Int. Cl. A01K 27/00

(52) U.S. Cl. 119/795

(57) ABSTRACT

Provided is a device that includes an item of apparel for a nonhuman animal and a means for communicating a warning effective at a distance from the animal to discourage an individual from approaching the animal. Optionally, the device of claim excludes any indication that the animal is a service animal. Also provided are a kit of the device packaged with instructions for using of the device and a method for providing a warning.

### CROSS REFERENCE TO RELATED APPLICATIONS

This application claims priority to U.S. Provisional Application Ser. No. 60/704,289, entitled “ANIMAL WEARABLE DEVICE WITH WARNING,” filed on Aug. 1, 2005, by inventor Caroline Aebi, the disclosure of which is incorporated by reference in its entirety.

### BACKGROUND

1. Technical Field

The invention relates generally to an item of apparel for a nonhuman animal and a means for communicating a warning pertaining to the animal.

2. Background Art

Owners of animals have traditionally been responsible for damage caused by the animals. Until recent times, most domesticated animals were used for agricultural purposes, and laws governing damages caused by animals were enacted to address the duties of the owners in an agricultural context. However, as farming has been relegated to a smaller sector of the economy, people are becoming increasingly exposed animals in nonagricultural and urban settings. Accordingly, laws relating to wild and domesticated animals continue to evolve.

In most jurisdictions, the owner of an animal has a legal duty to act in a reasonably prudent manner to prevent the animal from causing foreseeable harm to others. In the case of wild animals, the risk of harm is considered to outweigh their social utility. Accordingly, the owner of a wild animal is strictly liable for harm arising from the dangerous propensities characteristic of wild animals of its class. For example, the owner of a wild animal that is likely to inflict serious injury, e.g., a wolf, is responsible for any serious foreseeable injury caused by the animal. In contrast, domestic animals are usually considered harmless. Nevertheless, if an owner knows that his or her domesticated animal has abnormally dangerous propensities, the owner is responsible for the injuries caused by those propensities.

Domesticated animals serve a number of useful purposes. In addition to serving as pets, animals may be trained to perform as a service animal to assist to an individual with a disability. Such service animals perform some of the functions and tasks that the individual with a disability cannot perform for himself or herself. “Seeing eye dogs” are one type of service animal, used by some individuals who are blind. Other types of service animal include those that: alert persons with hearing impairments to sounds; pull wheelchairs or carry and pick up things for persons with mobility impairments; and assist persons with mobility impairments with balance. Some service animals wear special collars and harnesses and may be identified as service animals by their apparel, e.g., capes indicating their status as a service animal or a service animal in training. As service animals are typically trained to behave in a docile manner with respect to strangers, there is generally no need to warn others not to approach or pet such animals.

In addition, police, military and security personnel throughout the world have employed “police dogs” to perform search and rescue activities, and to locate persons suspected of crimes, using their keen sense of smell and hearing. When appropriately trained, police dogs also are effective in subduing suspects, especially those that have attempted to conceal themselves in locations that are difficult to access by police personnel. Thus, police dogs may be used to rout suspects hiding under vehicles, within confined spaces such as tunnels or crawl spaces within the buildings, and similar locations. Unlike service animals, police dogs may be trained to take aggressive action upon command and may be used to apprehend or subdue suspects. Nevertheless, as police dogs undergo extensive training to undertake aggressive actions only upon command, there is typically no need to warn others not to approach or pet police dogs.

Many states have adopted laws that make a dog owner subject to strict liability for any bite attack by his or her dog. For example, in certain jurisdictions, an owner of a dog who bites person is liable for any harm caused by the bite if the bite took place in on public property or on private property where the victim is not a trespasser. The owner is liable regardless of whether the dog previously had been vicious, whether the owner knew of such viciousness, or whether the owner was negligent in respect to the custody or care of such dog. Furthermore, a “bite” does not require a puncture or tearing away of the skin to cause a wound. In short, the owner of a dog that bites another person may be liable for all damages from the bite. Under certain interpretations of the law, even service animals, police dogs, and private guard dogs, in training or otherwise, are covered.

Recovery for damages caused by an animal, however, may be diminished by the actions of the injured party. When the injured party has acted in a manner that contributes to the injuries he or she has suffered, the damage recoverable from the owner may be reduced. For example, damages may be reduced if a dog is provoked by the injured party. Exemplary conduct that may be material to the issue of provocation includes: (1) coming into contact with the dog; (2) approaching the dog; and (3) acting in a threatening manner toward the dog or the dog's owner. Notably, recovery may be diminished for a bitten party who has prior knowledge of the dog's dangerous propensities or history of biting. Such knowledge may be imparted through a warning. For example, to warn individuals from petting a dog inside a kennel, a dog owner may post signs on the kennel to discourage the individual from reaching into the kennel.

Thus, it is generally in the interest of the owner of an animal such as a dog to ensure that the animal such that it does not harm innocent bystanders. A wide range of equipment is commercially available to assist an owner to control and/or restrain wild and domestic animals in the context of training or otherwise. Often, such equipment is provided in the form of animal apparel. Exemplary apparel for include leashes, collars, and harnesses. Such equipment may help animal owners may prevent their animals from causing harm to bystanders.

Nevertheless, such equipment does not discourage others from taking actions that may contribute to their becoming victims of an animal attack. For example, an owner walking a dog may be approached by an individual who may not know that the dog is skittish. The individual may inadvertently provoke the dog into biting by attempting to pet it without seeking prior permission from the animal's owner.

Thus, there is a need in the art for improved equipment, particularly those for use in controlling and/or restraining an animal that additionally provides a warning and/or other message pertaining to the animal, e.g., a communication that discourages others from approaching the animal.

### SUMMARY OF THE INVENTION

It is a general object of the present invention to address the above-mentioned drawback in prior art technologies by providing equipment and methods that physically associate a nonhuman animal with a means for communicating a warning pertaining to the animal.

In addition or in the alternative, the communicating means may be used to convey another message that pertains to the animal.

Additional objects, advantages and novel features of the invention are set forth in the description that follows, will become apparent to those skilled in the art upon examination of the following, and/or may be learned through routine experimentation upon practice of the invention.

In a first embodiment, the invention provides a device that includes an item of apparel for a nonhuman animal and a means for communicating a warning effective at a distance from the animal to discourage an individual from approaching the animal. The item of apparel, for example, may include a woven leash that is no more than about 6 feet in length. The communicating means may include, for example, a visual means that uses colors associated with a warning, e.g., black and yellow. In addition, the visual means may include a symbol or word associated with a caution warning. Optionally, the device of claim excludes any indication that the animal is a service animal.

In another embodiment, a kit is provided. The kit may include the device as described above packaged with instructions for using of the device.

In a further embodiment, a method is provided for providing a warning. The method involves situating a nonhuman animal at a location where one or more individuals unfamiliar with the animal may approach the animal and ensuring that the animal wears the device as described above.

### BRIEF DESCRIPTION OF THE DRAWINGS

FIG. 1 is a picture of dog apparel that employs the words “CAUTION DOG” as a means for communicating a warning.

FIG. 2 is an engineering schematic of a leash that employs the words “CAUTION DOG” as a means for communication a warning

FIG. 3 is a picture of a leash for use by a police K-9 unit.

### DETAILED DESCRIPTION OF THE INVENTION

Before the invention is described below, it is to be understood that this invention, unless specifically noted to the contrary, is not limited to any particular items of apparel or to any particular species, subspecies, or breed of animals, as such may vary. It is also to be understood that the terminology used herein is for the purpose of describing particular embodiments only, and is not intended to be limiting.

As used herein, the singular forms “a,” “an,” and “the” include both singular and plural referents unless the context clearly dictates otherwise. Thus, for example, reference to “a leash” includes a plurality of leashes as well as a single leash, reference to “a warning” includes a combination of warnings as well as a single warning, reference to “a symbol” includes a collection of symbols as well as single symbol, and the like.

In a first embodiment of the invention, then, a device is provided that includes a means for communicating a warning pertaining to an animal, e.g., to discourage an individual from approaching an animal. The device may also include an item of apparel for the animal. The device may, for example, effectively function as a “walking beware of animal sign.”

In addition or in the alternative to the item of apparel, a mechanism for attaching the communicating means with an item of apparel for the nonhuman animal. Optionally, a kit may be provided that includes the communicating means and instructions for using the device.

As used herein, the term “item of apparel” is used in its ordinary sense and refers to a wearable article such as a covering, adornment, clothing, garment, and the like. Thus, when an item of apparel for an animal is provided, the item may take any of a number of forms. For example, the item of apparel may include: a leash; a collar; a harness; a vest; a muzzle; or a combination thereof.

In addition, variations of any particular item of apparel may be provided. Leashes are typically available in different dimensions depending on the particular needs and wants of the owner. Longer leashes allow an animal tethered thereto a greater range of mobility. For certain service animal applications, a leash may have a length that exceeds 10 or 20 feet. Leashes having a length of about 75 feet may be of use with police dogs and K-9 units of police departments.

To provide an owner a greater degree of control over an animal, however, a shorter leash may be warranted. It has been found that leashes of no more than about 6 feet in length typically provide an owner a satisfactory degree of control over a dog for daily use, e.g., for walking. For greater control, leashes of no more than about 4 feet in length may be used. While leashes of either of fixed or variable lengths may be employed, a leash of a fixed length is preferred in situations where a leash of variable lengths is inappropriate. In addition, the width of the leash may vary. For example, a leash or a portion thereof may have a width of about 1.0 inch, 1.5 inches, 2.0 inches, or more.

The construction of the item of apparel may be selected according to the intended use of the item. For example, night-use apparel may be constructed from reflective and/or glow-in-the-dark materials. In addition, additional functionality may be provided when a power source is used. Typically, the power source includes a battery to power lighting sources and/or other electronic equipment.

The material of the item of apparel may vary as well. For example, the item of apparel may include leather, a fabric, and/or a metal. In addition or in the alternative, a polymeric material may be used. Exemplary polymeric materials include polyamide such as nylons, polyolefins such as polyethylenes, polypropylenes, and polybutylenes, and polyesters such as polyethylene terephthalate. The materials may be provided the woven or nonwoven form.

In any case, the item of apparel should be sized to fit the animal for which the apparel is intended. For example, the item apparel may be provided in standardized sizes for small, medium or large dogs. In addition or in the alternative, the item of apparel may be adjustable to provide a customized fit.

As discussed above, a means is provided for communicating a warning. Typically, the warning serves to discourage an individual from approaching the animal. However, additional or alternative warnings may be included. For example, the warning may serve to discourage an individual from touching (e.g., petting) the animal. When appropriate, the warning may communicate any potential danger associated with such acts. In the alternative, the warning may serve to provide an indication that the animal may behave in an unwelcome but nondangerous manner. In any case, the warning may be provided in a generalized form or a specific form that enumerates the particulars of the potential dangerous or unwelcome behavior of the animal in response to the individual's actions.

While the communicating means may be visual and/or audio in nature, visual means may be more suited of use in ordinary situations. Any of a number of visual features may be employed. For example, the visual communicating means may include a pattern or symbol associated with a caution warning, e.g., caution stripes. Such a pattern may be formed from a plurality of colors. Useful colors include those which are universally or commonly associated with caution/danger and those that draw attention to themselves, e.g., bright or unusual colors. In particular, the combination of black and yellow may be evocative of caution warnings while the color red may indicate danger. For example, individuals unfamiliar with a particular dog will avoid approaching the dog when the dog is led by its owner on a double-sided leash about 6 feet in length and 1.5 inches in with caution stripes on both exteriors surfaces. Similarly, a bright yellow leash having words of warning such as “CAUTION DOG” printed repeated on both side thereof in a contrasting color (e.g., black, red, green, blue, or a combination of any of the foregoing) may function in the same manner. Such words may be printed in bold face and/or capital letters for emphasis and/or clarity.

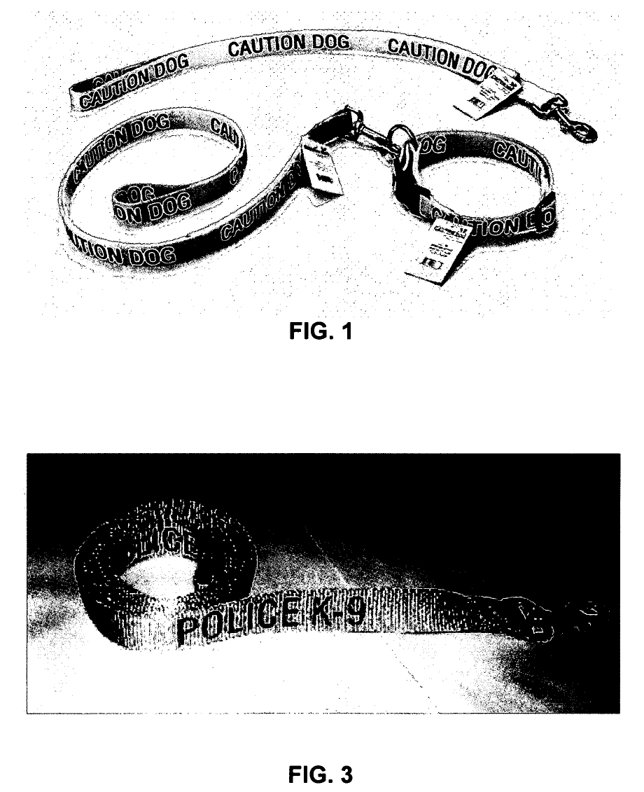

Such animal apparel have been produced and tested. FIG. 1 is a photograph of animal apparel, i.e., a leash by itself and a leash in combination with a collar, wherein each item includes “CAUTION DOG” in black as words of warning on a yellow background. FIG. 2 shows an engineering diagram of the leash shown in FIG. 1. The leash is made from polyester, has a thickness of 2 mm, and has a color designated as 7405C yellow. These items have been shown to serve their intended functions, e.g., serve as “walking beware of dog signs” to casual bystanders.

A visual communicating means may additionally or alternatively include one or more words of warning. Such words of warning may be provided in a single language or a plurality of languages. While a communicating means that includes words of warning in a plurality of languages may be more versatile for different locations, a single language may be more effective in communicating a clearer or undiluted message. Exemplary languages of interest include English, French, Spanish, German, Chinese, Japanese, and Korean. In any case, any symbols, patterns, words, and the like employed by the communicating means should be appropriate to the location of its use. For example, in a location where English is used, the communicating means may include one or more words of warning in English.

In general, it is desirable provide the communicating means such that it is effective at a distance from the animal physically associated therewith. In particular, when the communicating means is intended to provide a warning that serves to discourage an individual from approaching the animal, the effective distance of the communicating means should be sufficient to provide ample notice to deter an individual traveling toward the animal from continuing on his or her trajectory. In addition, the effective distance may be keyed to the physical dimensions of the inventive device or a portion thereof. For example, when a leash is used, the effective distance of the communicating means may be greater or equal to the length of the leash. Thus, for a leash of four or six foot length, the effective distance of the communicating means may be at least about 6 ft or 10 ft.

When a visual communicating means is used, it is also desirable to maximize the visibility of the communicating means to the fullest extent practicable. For example, the visual communicating means should be visible from a plurality of directions that define a viewing angle. Typically, a viewing angle of at least 180° may be employed. A viewing angle of 360° allows the communicating means to be seen by an individual to the front, back and all sides of an animal associated with the communicating means.

Visibility of a communicating means may be enhanced by its placement. Typically, a visual communicating means will occupy an exterior surface of the inventive device. To enhance visibility of the communicating means, it may occupy a plurality of exterior surfaces of the device. Adequate visibility may be achieved when the visual means occupies a surface area that represents at least 25% or 50% of all visible surfaces of the device.

Generally, but not necessarily, the communicating means is physically associated with an item of apparel. In some instances, the communicating means is an integral part of the item of apparel. For example, the communicating means may be printed on, sewn to, or woven into the item of apparel. In such a case, the item of apparel may be sized appropriately to ensure that the communicating means has an adequate effective distance.

In addition or in the alternative, the communicating means and the item of apparel may be attached to each other. Accordingly, a mechanism may be provided for attaching the item of apparel with the communicating means and/or vice versa. Any of a number of mechanisms may be used. For example, the attaching mechanism may be selected from the group consisting of snaps, hook and loop connectors, buckles, friction fittings, zippers, elastic bands, and combinations thereof.

As discussed above, the invention is particularly suited for use by an owner of an animal such as a dog to ensure that the animal such that it does not harm bystanders. The term “owner,” as in “animal owner,” is used herein refers to a person who has an interest in or is responsible for control over the animal. The term includes agents and other entities authorized to control and/or care for the animal. As an animal owner generally has an interest in preventing the animal from causing harm, the invention may serve to inform those individuals unaware that their own actions, e.g., approaching the animal, may induce the animal to injure themselves.

Thus, in another embodiment, the invention involves a method for providing a warning. The method involves situating a nonhuman animal wearing the inventive device at a location where one or more individuals unfamiliar with the animal may approach the animal. For example, the location may be a public place where the owner may wish to walk the animal. Alternatively, the location may be situated on private property on which the owner may wish to bring the animal.

The invention is suited for both wild and domesticated animals. Exemplary domesticated animals include dogs, cats, cattle, horses, pigs, birds, and reptiles. In addition, there are a number of risk factors that may be taken into consideration in deciding whether an owner would employ the invention. For example, a dog owner may want to warn others that his or her dog has aggressive tendencies or is prone to biting when provoked. Risk factors for such a propensity include, for example, (1) the dog's history of biting a human being or another nonhuman animal, (2) the present health or injuries of the dog; (3) the dog's gender (male dogs are typically more aggressive than female dogs); (4) whether the dog is neutered or spayed (unneutered dogs tend to be more aggressive); and (5) whether the dog lacks training or socialization prior to the age of 14 weeks.

There is ongoing debate as to whether certain breeds of dogs are inherently more likely to bite than others. For example, some studies show that one-third of all liability claims against homeowners stem from dog bites. As a result, certain insurers are reevaluating coverage for homeowners who share their living space with large, powerful breeds such as rottweilers, German shepherds, Doberman pinschers, akitas, pit bulls, or chows. However, there is also consensus that even the calmest, most gentle breeds may bite or snap if they are injured, ill or mistreated. The invention is suited for any dog, regardless of its breed or ancestry, depending on context of the invention's use.

In particular, the invention may be used to the advantage of insurers whose policies cover homeowners and others who may own dangerous animals such as dogs having a propensity to bite strangers. For example, an insurer may issue a policy that requires the owner of a dog who has bitten before to use the invention. This benefits the insurer regardless whether the dog bite another. If the dog wearing the inventive device bites an individual and the individual bring suit, the insurer may defend by asserting contributory negligence on the part of the individual. If, however, the dog bites when the invention is not in use, the insurer may deny coverage.

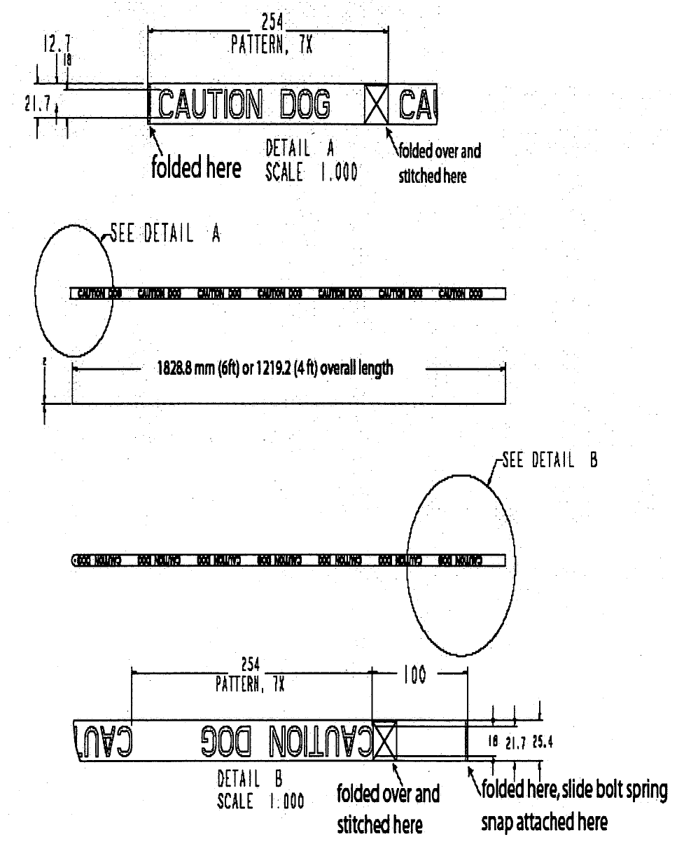

Variations of the present invention will be apparent to those of ordinary skill in the art. Such variations may depend on the intended use or functionality of the invention. As a result, certain features of the invention may be employed while others may be omitted when the invention is employed in a particular context. For example, when the inventive device is to be used on a police dog or a service animal, the device may include an indication to that effect, visual or otherwise. As shown in FIG. 3, a leash of the invention may be used with a police K-9 unit. The leash is generally yellow in background color with “POLICE K-9” text in black. The yellow and black colors serve as a means for communicating a warning, whereas the text itself serves to indicate that an animal wearing the leash is a service animal. Similarly, when the inventive device is not intended to be used on a police dog or service animal, the device may exclude such an indication.

It is to be understood that, while the invention has been described in conjunction with the preferred specific embodiments thereof, the foregoing description is intended to illustrate and not limit the scope of the invention. Other aspects, advantages, and modifications within the scope of the invention will be apparent to those skilled in the art to which the invention pertains.

I claim:

1. A device, comprising:
an item of apparel for a nonhuman animal; and
a means for communicating a warning effective at a distance from the animal to discourage an individual from approaching the animal.

2. The device of claim 1, wherein the item of apparel comprises a leash.

3. The device of claim 2, wherein the leash is no more than about 6 feet in length.

4. The device of claim 3, wherein the leash is no more than about 4 feet in length.

5. The device of claim 2, wherein at least a portion of the leash has a width of at least about 1.0 inches.

6. The device of claim 5, wherein substantially the entire leash has a width of about 1.0 inches.

7. The device of claim 1, wherein the item of apparel is at least partially woven.

8. The device of claim 1, wherein the communicating means comprises a visual means.

9. The device of claim 8, wherein the visual means comprises a plurality of colors associated with the warning.

10. The device of claim 9, wherein the colors consist essentially of black and yellow.

11. The device of claim 8, wherein the visual means comprises a symbol associated with a caution warning.

12. The device of claim 8, wherein the visual means comprises words of warning.

13. The device of claim 19, wherein the visual means is visible from a plurality of directions.

14. The device of claim 13, wherein visual means is visible from directions that are located 180° from each other.

15. The device of claim 8, wherein the visual means occupies a plurality of exterior surfaces of the device.

16. The device of claim 8, wherein the visual means occupies a surface area that represents at least 25% of all visible surfaces of the device.

17. The device of claim 1, wherein the effective distance of the communicating means is at least 6 ft.

18. The device of claim 1, excluding any indication that the animal is a service animal.

19. A kit, comprising:
the device of claim 1; and
instructions for using of the device.

20. A method for providing a warning, comprising situating a nonhuman animal wearing the device of claim 1 at a location where one or more individuals unfamiliar with the animal may approach the animal.
